(19) United States
(12) Patent Application Publication
(10) Pub. No.: US 2015/0206282 A1
(43) Pub. Date: Jul. 23, 2015

(54) IMAGE PROCESSING DEVICE, IMAGE PROCESSING METHOD, AND IMAGE PROCESSING PROGRAM

(71) Applicant: PANASONIC INTELLECTUAL PROPERTY MANAGEMENT CO., LTD., Osaka-shi (JP)

(72) Inventor: Shintaro Kudo, Kanagawa (JP)

(21) Appl. No.: 14/423,814

(22) PCT Filed: Aug. 30, 2013
(86) PCT No.: PCT/JP2013/005140

§ 371 Date: Feb. 25, 2015

(30) Foreign Application Priority Data
Aug. 31, 2012 (JP) 2012-192072

(51) Int. Cl. G06T 3/40; H04N 5/262; H04N 5/232

(52) U.S. Cl. CPC G06T 3/4038; H04N 5/23293; H04N 5/23229; H04N 5/2621; H04N 5/2628; G06T 2210/22; G06T 2200/32; G06T 2200/28

(57) ABSTRACT

A specific object is designated from a captured image captured by an imaging unit of an image processing device. An extraction processing unit extracts the specific object and the coordinates thereof. A composition image generation unit makes segmentation composition points coincide with the coordinates of the specific object at a first trimming ratio with respect to the captured image to thereby generate composition images which are trimming regions. When a calculation unit determines that protrusion regions are present in the composition images, the composition image generation unit generates reduced composition images including the specific object at a second trimming ratio which is lower than the first trimming ratio.

### TECHNICAL FIELD

The present invention relates to an image processing device such as a digital camera or a portable terminal with a camera which generates a preferred composition image of a captured image including a specific object, an image processing method, and an image processing program.

### BACKGROUND ART

In recent years, digital cameras, mobile phones with a camera, and the like have become widespread, and thus an environment in which users are easily capable of taking pictures has been provided. In addition, photo-editing software is attached at the time of purchasing an image processing device or at the time of purchasing a personal computer, and thus an environment has been also provided in which users can easily perform processing such as trimming at home or the like. Further, a digital camera having a trimming function so as to be capable of better composition editing is also known (see Patent Literature 1 and Patent Literature 2).

According to Patent Literature 1, face detection means for detecting a person and composition control means for generating a composition-adjusted image are included. Patent Literature 1 discloses that the composition-adjusted image can be acquired by setting four intersection points, formed by two lines for performing division into substantially three equal parts in a horizontal direction and two lines for performing division into substantially three equal parts in a vertical direction, as specific positions and disposing the specific positions on a person's face. In addition, according to Patent Literature 2, focus position acquisition means for bringing a subject into focus and image generation means for generating a plurality of composition images are included. Patent Literature 2 discloses that the plurality of composition images can be acquired for a plurality of trimming regions by setting a plurality of trimming regions having different sizes centering on a focus position.

### CITATION LIST

### Patent Literature

Patent Literature 1: Japanese Patent No. 4869270

Patent Literature 2: Japanese Patent No. 4929631

### SUMMARY OF INVENTION

### Technical Problem

However, in the trimming disclosed in Patent Literature 1 and Patent Literature 2, means for simply trimming a portion of a captured image is used and this does not have a particular advantage as compared with the trimming of inexpensive photo-editing software. In addition, when trimming is performed at a constant ratio, surplus portions may be generated in captured images as disclosed in Patent Literature 1, and thus trimming images having different aspect ratios are obtained. For example, even when photos have an L size, the photos are not likely to be able to be accommodated in an L-size album due to their different trimming sizes. Further, when trimming at a constant ratio is performed on the photos, the presence of a plurality of similar composition images results in compositions having no conspicuous change, and thus there is a problem in that a user is unlikely to be provided with composition images which have adventurous changes.

The present invention is contrived in view of the above-mentioned reasons, and an object thereof is to provide an image processing device, an image processing method, and an image processing program which are capable of acquiring a plurality of composition images having different trimming ratios and proposing an adventurous composition to a user.

### Solution to Problem

An image processing device according to an aspect of the present invention includes: an imaging unit which captures an image including a specific object; an extraction processing unit which extracts the specific object in the captured image; a composition image generation unit that generates a plurality of composition images, which have a first trimming ratio and respectively have a plurality of different segmentation composition points being disposed in the specific object, from the captured image; a calculation unit which calculates whether or not a protrusion region protruding from an outer edge of the captured image is present in the plurality of composition images generated based on the first trimming ratio; and a display unit which displays the captured image and the composition images, wherein when the calculation unit calculates that one or more protrusion regions are present, the composition image generation unit generates reduced composition images which include the specific object and have a second trimming ratio lower than the first trimming ratio.

It is preferable that the image processing device is configured so that when the calculation unit calculates that one or more protrusion regions are present in the reduced composition images having the second trimming ratio, the composition image generation unit generates further reduced composition images, including the specific object, which have a third trimming ratio lower than the second trimming ratio.

It is preferable that the image processing device is configured so that the reduced composition image having the second trimming ratio has an aspect ratio constituted by a ratio of a horizontal width to a vertical width of the captured image, and the composition image generation unit processes the composition image including the protrusion region among the reduced composition images to generate a composition image which is a reduced composition image having a reverse aspect ratio while maintaining the second trimming ratio.

It is preferable that the image processing device is configured so that the reduced composition image having the second trimming ratio includes an aspect ratio constituted by a ratio of a horizontal width to a vertical width of the captured image, and the composition image generation unit processes the composition image including the protrusion region among the reduced composition images to generate a composition image which is a reduced composition image having a reverse aspect ratio at the third trimming ratio.

It is preferable that the image processing device is configured so that the composition image generation unit disposes a different segmentation composition point from the segmentation composition points in the specific object with respect to the composition image having the reverse aspect ratio.

It is preferable that the image processing device is configured so that the composition image generation unit moves the segmentation composition point in a vertical direction.

It is preferable that the image processing device is configured so that the composition image generation unit moves the segmentation composition point in a transverse direction.

It is preferable that the image processing device is configured so that when the captured image has a longer dimension horizontally, the composition image generation unit moves the segmentation composition point in a vertical direction, and when the captured image has a longer dimension vertically, the composition image generation unit moves the segmentation composition point in a transverse direction.

It is preferable that the image processing device is configured so that an aspect ratio is reversed also with respect to a composition image that does not include a protrusion region.

It is preferable that the image processing device is configured so that when a proportion of a protrusion region with respect to the composition image is equal to or less than a predetermined value, the segmentation composition point is shifted so that a trimming region fits within the captured image.

It is preferable that the image processing device is configured so that the first trimming ratio is in a range of 70% to 85%, and the second trimming ratio is in a range of 40% to 60%.

It is preferable that the image processing device is configured so that there are four segmentation composition points

An image processing method according to an aspect of the present invention includes the steps of; capturing an image including a specific object; extracting the specific object in the captured image; generating a plurality of composition images, which have a first trimming ratio and respectively have a plurality of different segmentation composition points being disposed in the specific object, from the captured image; calculating whether or not a protrusion region protruding from an outer edge of the captured image is present in the plurality of composition images generated based on the first trimming ratio; generating reduced composition images which include the specific object and have a second trimming ratio lower than the first trimming ratio when it is calculated that one or more protrusion regions are present; and displaying the plurality of composition images.

An image processing program according to an aspect of the present invention causes a computer to process a captured image, the program causing the computer to perform: a process of capturing an image including a specific object; a process of extracting the specific object in the captured image; a process of generating a plurality of composition images, which have a first trimming ratio and respectively have a plurality of different segmentation composition points being disposed in the specific object, from the captured image; a process of calculating whether or not a protrusion region protruding from an outer edge of the captured image is present in the plurality of composition images generated based on the first trimming ratio; a process of generating reduced composition images which include the specific object and have a second trimming ratio lower than the first trimming ratio when it is calculated that one or more protrusion regions are present; and a process of displaying the plurality of composition images.

### Advantageous Effects of Invention

According to the present invention, it is possible to provide a plurality of composition images having different trimming ratios to a user and to propose an adventurous composition image. In addition, since a composition image centers on a specific object, it is also possible to automatically generate a composition image conforming to a region that a user desires to trim, without depending on the user.

### BRIEF DESCRIPTION OF DRAWINGS

FIG. 1 is a block diagram showing an example of an image processing device according to the present invention.

FIG. 2 is a schematic diagram of a captured image and a trimming region which illustrates an example of a basic concept of the present invention; FIG. 2(a) shows a captured image, FIG. 2(b) shows a captured image and a trimming region, and FIG. 2(c) shows trimming regions and segmentation composition points.

FIG. 3 is a schematic diagram of a trimming region illustrating an example of a basic concept of the present invention; FIG. 3(a) shows the designation of a specific object which is performed by a user, FIG. 3(b) shows a trimming region including the specific object, FIG. 3(c) shows a trimming region including a protrusion region, and FIG. 3(d) shows a change in a trimming ratio of the trimming region.

FIG. 4 shows an example of a basic concept of the present invention and is a schematic diagram illustrating how a trimming region changes; FIG. 4(a) shows a captured image, FIG. 4(b) shows first to fourth composition images, FIG. 4(c) shows the reduction processing of the second to fourth composition images, and FIG. 4(d) shows composition images displayed on a display unit.

FIG. 5 is a flowchart showing an example of a procedure of a basic concept of the present invention.

FIG. 6 shows a procedure of a basic concept of the present invention and is a flowchart showing an example of a method of determining whether or not a trimming region is present in a captured image.

FIG. 7 shows an example of a basic concept of the present invention and is a schematic diagram illustrating the flowcharts of FIGS. 5 and 6 through a specific example; FIG. 7(a) shows first to fourth composition images, FIG. 7(b) shows the reduction processing of the second to fourth composition images, and FIG. 7(c) shows the reduction processing of the second and fourth composition images.

FIG. 8 is a flowchart illustrating a procedure according to a first embodiment.

FIG. 9 is a schematic diagram illustrating the first embodiment through a specific example; FIG. 9(a) shows first to fourth composition images, FIG. 9(b) shows the reduction processing of the second to fourth composition images, FIG. 9(c) shows the reduction processing of the second to fourth composition images of which the aspect ratios are changed, and FIG. 9(d) shows the reduction processing of the third and fourth composition images.

FIG. 10 is a flowchart illustrating a procedure according to a second embodiment of the present invention.

FIG. 11 is a schematic diagram illustrating the second embodiment through a specific example; FIG. 11(a) shows first to fourth composition images, FIG. 11(b) shows the reduction processing of the second to fourth composition images, FIG. 11(c) shows the reduction processing of the second to fourth composition images of which the aspect ratios and the segmentation composition points are changed, and FIG. 11(d) shows the reduction processing of the second composition image.

FIG. 12 is a flowchart illustrating an additional step according to a third embodiment of the present invention.

FIG. 13 is a flowchart illustrating the third embodiment of the present invention.

FIG. 14 is a schematic diagram illustrating the third embodiment through a specific example; FIG. 14(a) shows first to fourth composition images, FIG. 14(b) shows the reduction processing of the second to fourth composition images, and FIG. 14(c) shows changes in aspect ratios and segmentation composition points of the second and fourth composition images.

FIG. 15 is a flowchart illustrating a fourth embodiment of the present invention.

FIG. 16 is a schematic diagram illustrating the fourth embodiment of the present invention through a specific example; FIG. 16(a) shows first to fourth composition images, FIG. 16(b) shows the reduction processing of the second to fourth composition images, and FIG. 16(c) shows changes in an aspect ratio and segmentation composition points of the fourth composition image.

FIG. 17 is a flowchart illustrating a fifth embodiment of the present invention.

FIG. 18 is a schematic diagram illustrating the fifth embodiment through a specific example; FIG. 18(a) shows a positional relationship between a trimming region and a captured image and FIG. 18(b) shows the movement of the trimming region to the inside of the captured image.

FIG. 19 is a flowchart illustrating a procedure according to a sixth embodiment of the present invention.

FIG. 20 is a schematic diagram illustrating the sixth embodiment through a specific example; FIG. 20(a) shows first to fourth composition images, FIG. 20(b) shows the reduction processing of the second to fourth composition images, and FIG. 20(c) shows changes in a trimming ratio, an aspect ratio, and a segmentation composition point of the second composition image.

### DESCRIPTION OF EMBODIMENTS

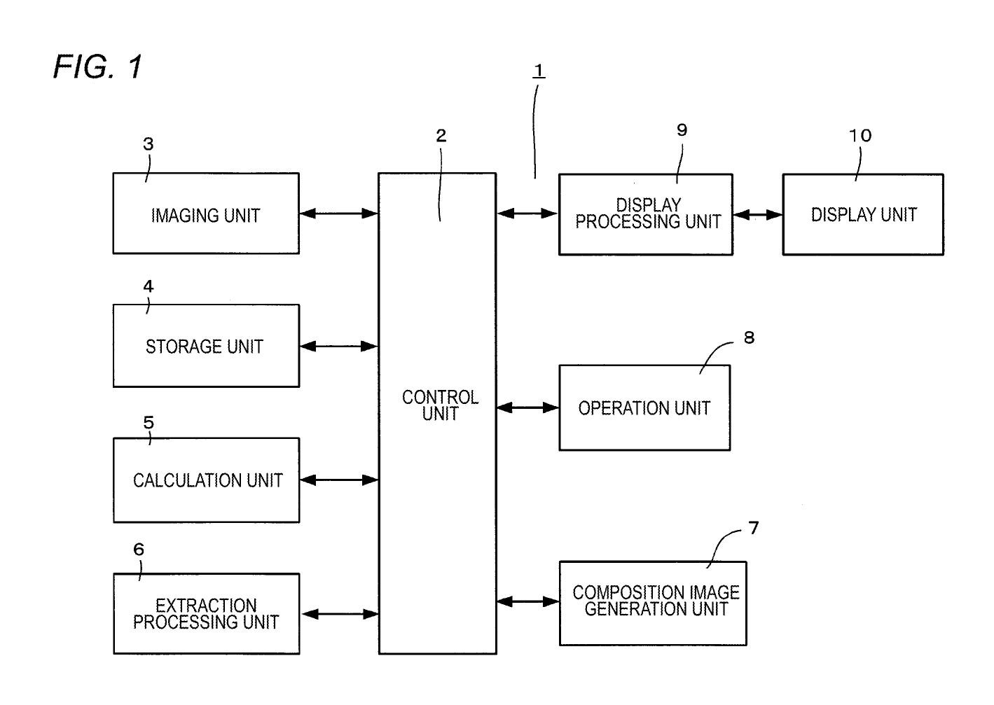

Hereinafter, preferred embodiments of an image processing device, an image processing method, and an image processing program according to the present invention will be described in detail with reference to FIGS. 1 to 18.

FIG. 1 is a block diagram showing an example of the image processing device according to the present invention.

An image processing device 1 is, for example, a mobile phone such as a smartphone, a tablet, a portable terminal with a camera, a digital camera, or the like. The image processing device 1 includes a control unit 2, an imaging unit 3, a storage unit 4, a calculation unit 5, an extraction processing unit 6, a composition image generation unit 7, an operation unit 8, a display processing unit 9, a display unit 10, and the like. The control unit 2 has a microprocessor configuration including a CPU, a RAM, a ROM, and the like. The control unit performs control of the overall image processing device 1 in accordance with a control program stored in the ROM and performs control of executing various types of processing functions to be described later. The imaging unit 3 includes an imaging lens for imaging a specific object 30 to be described later or an imaging element constituted by an aggregate of a large number of pixels such as a CCD or a CMOS sensor. The storage unit 4 stores image data captured by the imaging unit 3 and various pieces of information data required for the execution by the control unit 2. A configuration having no imaging unit 3 may be adopted. In this case, it is possible to perform image processing of the present invention on the image data stored in the storage unit 4.

The calculation unit 5 performs various types of calculations such as the calculation of a trimming ratio M to be described later, coordinates, and the like in response to a command by the control unit 2. The extraction processing unit 6 extracts the specific object 30 from an image (captured image) 20, to be described later, which is captured by the imaging unit 3. The composition image generation unit 7 trims a trimming region 40, to be described later, which includes the specific object 30 from the captured image 20 to thereby generate a plurality of composition images 41, 42, 43, . . . . The operation unit 8 includes a shutter button, a main switch, a processing mode change-over switch, and the like. When the switches and the button are operated, various types of signals are transmitted to the control unit 2. The display processing unit 9 controls a display magnification, a division display, and the like of the captured image 20 and the like which are displayed on the display unit 10. In addition, the display processing unit converts an operation such as tapping the display unit 10 into a manipulation signal and transmits the signal to the control unit 2.

The display unit 10 is a display such as a liquid crystal panel or an organic EL panel. The display unit 10 may be a user interface (UI) type touch panel for performing various types of processes by being touched using a finger or a pen or may double as the operation unit 8. In addition, the display unit 10 displays an image captured by the imaging unit 3 and a screen for performing various types of operations or displays a through image (live-view image) which is periodically output from an imaging element such as a CCD. A user can adjust a composition or adjust a zooming magnification while viewing the through image.

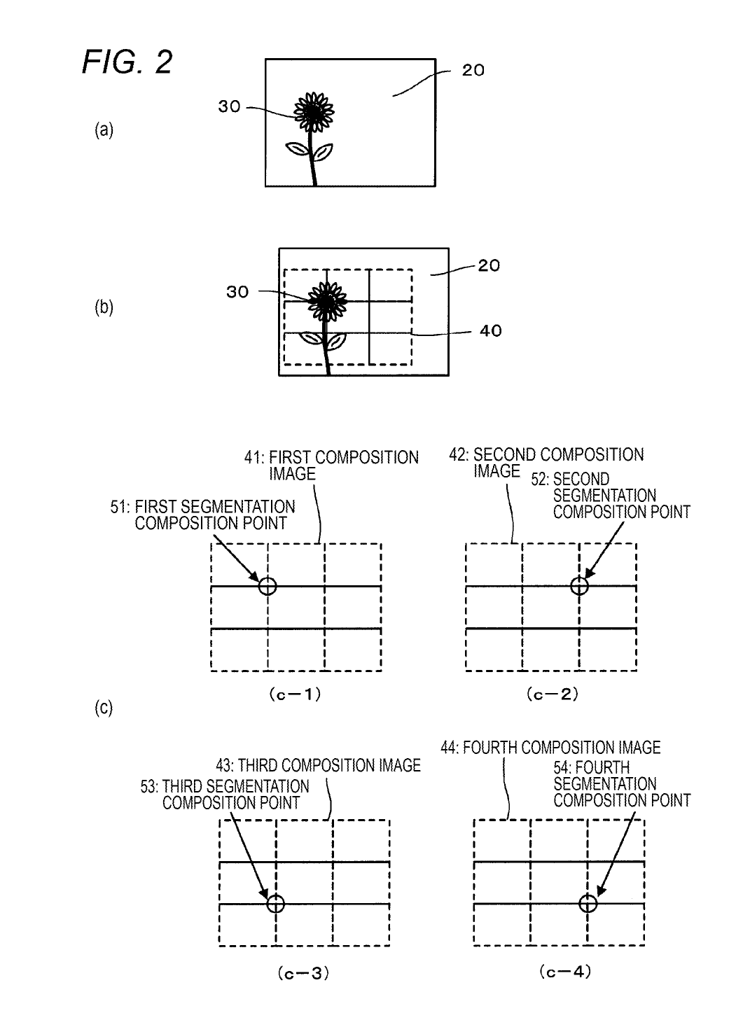

FIG. 2 is a schematic diagram of a captured image and a trimming region which illustrates an example of a basic concept of the present invention. FIG. 2(a) shows a captured image, FIG. 2(b) shows a captured image and a trimming region, and FIG. 2(c) shows trimming regions and segmentation composition points.

The captured image 20 of FIG. 2(a) is a photo taken by a user through the imaging unit 3 of the image processing device 1. The captured image 20 includes the specific object 30 that a user desires to trim. In FIG. 2(b), the trimming region 40 with the specific object 30 as a starting point is set with respect to the captured image 20. The trimming region 40 is shown as a 3 by 3 block in this embodiment. In addition, various blocks such as a 2 by 3 block, a 4 by 4 block, and a 5 by 5 block can be configured.

In the 3 by 3 block, four intersection points between horizontal and vertical lines are generated. In the present invention, a description will be given on the assumption that the intersection points are segmentation composition points (see FIG. 2(c)). In the segmentation composition points, the segmentation composition point on the upper left side of the drawing is a first segmentation composition point 51, the segmentation composition point on the upper right side of the drawing is a second segmentation composition point 52, the segmentation composition point on the lower left side of the drawing is a third segmentation composition point 53, and the segmentation composition point on the lower right side of the drawing is a fourth segmentation composition point 54. In addition, the trimming region 40 including the first segmentation composition point 51 is a first composition image 41 (see c-1 in the figure), and the trimming region 40 including the second segmentation composition point 52 is a second composition image 42 (see c-2 in the figure). Further, the trimming region 40 including the third segmentation composition point 53 is a third composition image 43 (see c-3 in the figure), and the trimming region 40 including the fourth segmentation composition point 54 is a fourth composition image 44 (see c-4 in the figure). In the embodiments of the present invention, a description will be given of a method of generating the composition images 41 to 44 by making the segmentation composition points 51 to 54 mentioned above coincide with coordinates of the specific object 30.

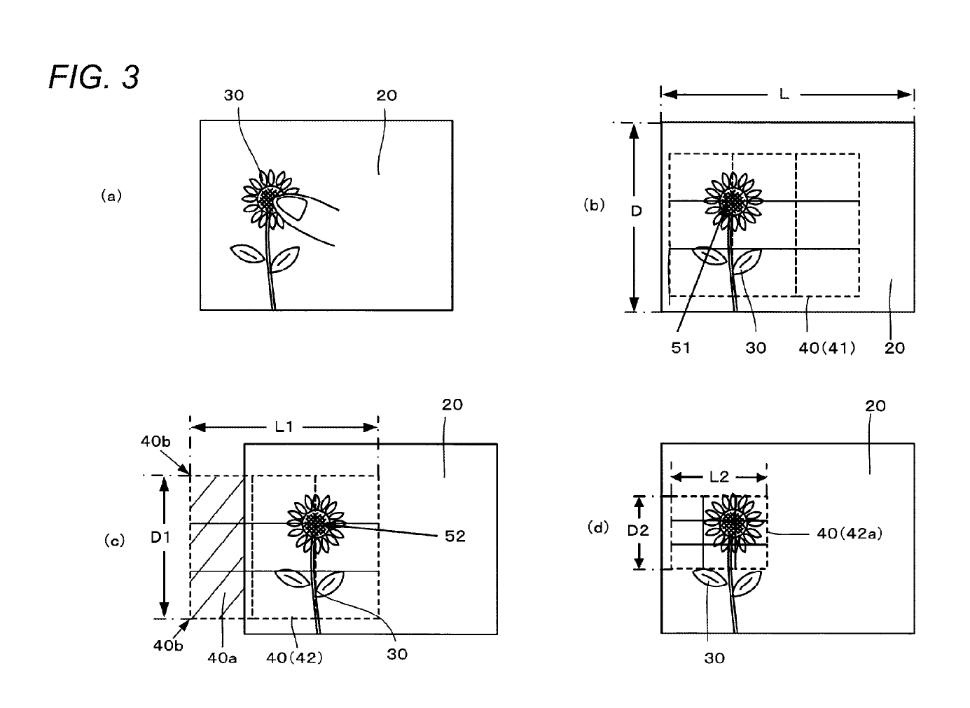

FIG. 3 is a schematic diagram of a trimming region illustrating an example of a basic concept of the present invention. FIG. 3(a) shows the designation of a specific object which is performed by a user, FIG. 3(b) shows a trimming region including the specific object, FIG. 3(c) shows a trimming region including a protrusion region, and FIG. 3(d) shows a change in a trimming ratio of the trimming region.

(1) A user specifies the captured image (including a through image) 20 that he or she desires to trim, and designates the specific object 30 from the captured image 20 displayed on the display unit 10 by using a finger or a pen (see FIG. 3(a)). (2) Next, the composition image generation unit 7 makes the coordinates of the specific object 30 conform to the first segmentation composition point 51 to thereby generate the first composition image 41 (see FIG. 3(b)). (3) Then, the composition image generation unit 7 makes the coordinates of the specific object 30 conform to the second segmentation composition point 52 to thereby generate the second composition image 42. In this embodiment, the trimming region 40 of the second composition image 42 includes a protrusion region 40a (see oblique lines in the drawing) which protrudes from the region (outer edge) of the captured image 20 (see FIG. 3(c)). (4) Further, when the trimming region includes the protrusion region 40a, the trimming ratio M is changed to a smaller ratio so that a reduced composition image 42a of the second composition image 42 fits within the captured image 20 (see FIG. 3(d)).

It is possible to determine whether or not the protrusion region 40a mentioned above is present, for example, by calculating whether or not vertexes 40b formed in the trimming region 40 are included in the region of the captured image 20 using the calculation unit 5 on the basis of coordinates. In this manner, when the protrusion region 40a is generated, the trimming region 40 is reduced so that the trimming region 40 fits within the captured image 20. Accordingly, a protruding composition changes, and thus it is possible to provide an adventurous composition to a user. In addition, when it is determined whether or not a protrusion region 40a is present, the coordinates of the overlapping vertexes 40b need not be exactly inside those of outer edge of the captured image 20, and a small margin is permissible.

The trimming ratio M of the trimming region 40 may be programmed in advance or may be set by a user. A first trimming ratio M1 is determined depending on the size of the captured image 20 which is displayed (or printed), particularly, depending on an aspect ratio of the horizontal width and the vertical width. For example, the horizontal width in the transverse direction of the captured image 20 is set to be L, the vertical width in the vertical direction thereof is set to be D, the horizontal width of the trimming region 40 is set to be L1, the vertical width thereof in the vertical direction is set to be D1, and (L1/L) or (D1/D) is set to be the first trimming ratio M1. In addition, the horizontal width of the reduced trimming region 40 (reduced composition image 42a) is set to be L2, the vertical width thereof is set to be D2, and (L2/L) or (D2/D) is set to be a second trimming ratio M2. Further, an aspect ratio which is a ratio of the horizontal width to the vertical width is set to be N (L/D). The aspect ratios N of the respective composition images originating from differences in the trimming ratio M are not particularly limited and may be L:D=L1:D1=L2:D2 or may be L:D≠L1:D1≠L2:D2. In the embodiment, the trimming ratio M is specified as a ratio between lengths, but is not particularly limited. The trimming ratio may be specified as a ratio between areas or may be specified as a ratio between the numbers of pixels. Basically, the relation of M1>M2> . . . is satisfied.

A method of designating the specific object 30 using a finger or the like has been described. However, the method is not limited thereto, and the specific object may be automatically designated. For example, a user may cause the captured image 20 set as a target for trimming to be displayed on the display unit 10 and perform a trimming instruction using the operation unit 8, the display unit 10, or the like. In a trimming mode, the extraction processing unit 6 can also extract the specific object 30, for example, using a face recognition method disclosed in Japanese Patent No. 4869270. The specific object 30 is a subject such as a person, an animal, a plant, or a landscape that a user desires to image. In the present invention, the specific object 30 will be described using a flower as an example.

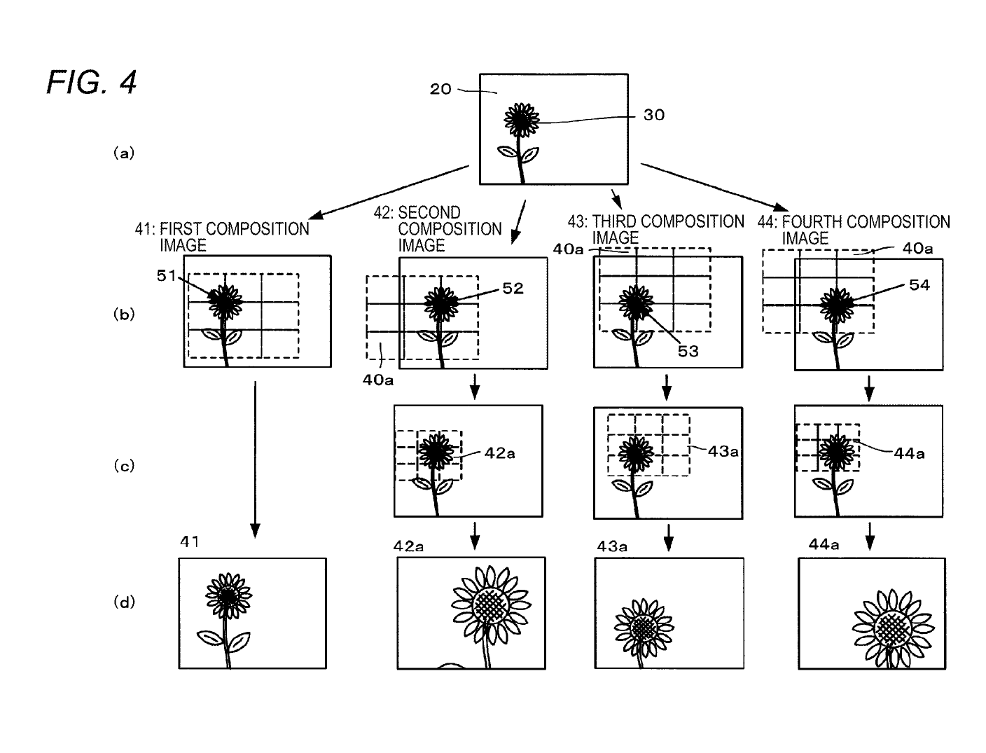

FIG. 4 shows an example of a basic concept of the present invention and is a schematic diagram illustrating how a trimming region changes. FIG. 4(a) shows a captured image, FIG. 4(b) shows first to fourth composition images, FIG. 4(c) shows the reduction processing of the second to fourth composition images, and FIG. 4(d) shows composition images displayed on a display unit.

The composition image generation unit 7 generates the first composition image 41 to the fourth composition image 44 at the first trimming ratio M1 on the basis of the specified captured image 20 (see FIGS. 4(a) and 4(b)). The first composition image 41 is generated by making the first segmentation composition point 51 coincide with the coordinates of a specific object, and the second composition image 42 is generated by making the second segmentation composition point 52 coincide with the coordinates of the specific object. The third composition image 43 is generated by making the third segmentation composition point 53 coincide with the coordinates of the specific object, and the fourth composition image 44 is generated by making the fourth segmentation composition point 54 coincide with the coordinates of the specific object. Among the first composition image 41 to the fourth composition image 44, the first composition image 41 does not include a protrusion region 40a, and thus the first composition image 41 is stored in the storage unit 4. On the other hand, the second composition image 42 to the fourth composition image 44 include the protrusion region 40a, and thus the composition images 42, 43, and 44 are reduced so as to fit within the region of the captured image 20. The composition image generation unit 7 generates reduced composition images 42a, 43a, and 44a which are reduced at the second trimming ratio M2 or a third trimming ratio M3 (see FIG. 4(c)), and the reduced composition images are stored in the storage unit 4.

As a result of setting the trimming region 40, when a protrusion region 40a is present, the trimming ratio M is reduced (M1, M2 and M3 in order) until the protrusion region 40a disappears. In addition, it is preferable that the first trimming ratios M1 be the same with respect to the composition images 41 to 44, but the second trimming ratio M2 and the third trimming ratio M3 may be the same as or different from each other with respect to the composition images 42 to 44. Further, a stable composition image is obtained by determining the range of the trimming ratio M. For example, the first trimming ratio M1 is in a range between 70% and 85%, and the second trimming ratio M2 is in a range between 40% and 60%.

The generated four reduced composition images 41, 42a, 43a, and 44a are displayed on the display unit 10 (see FIG. 4(d)). A user designates a preferred composition image, and the control unit 2 stores the designated composition image in the storage unit 4. Here, the four reduced composition images 41, 42a, 43a, and 44a are enlarged to the sizes suitable for being displayed on the display unit 10, but the enlargement is not related to a trimming ratio. The four reduced composition images 41, 42a, 43a, and 44a may be simultaneously displayed on the display unit 10 or may be displayed as individual composition images. In addition, a display magnification can be freely selected by a user through an operation such as tapping, pinch-in, or pinch-out.

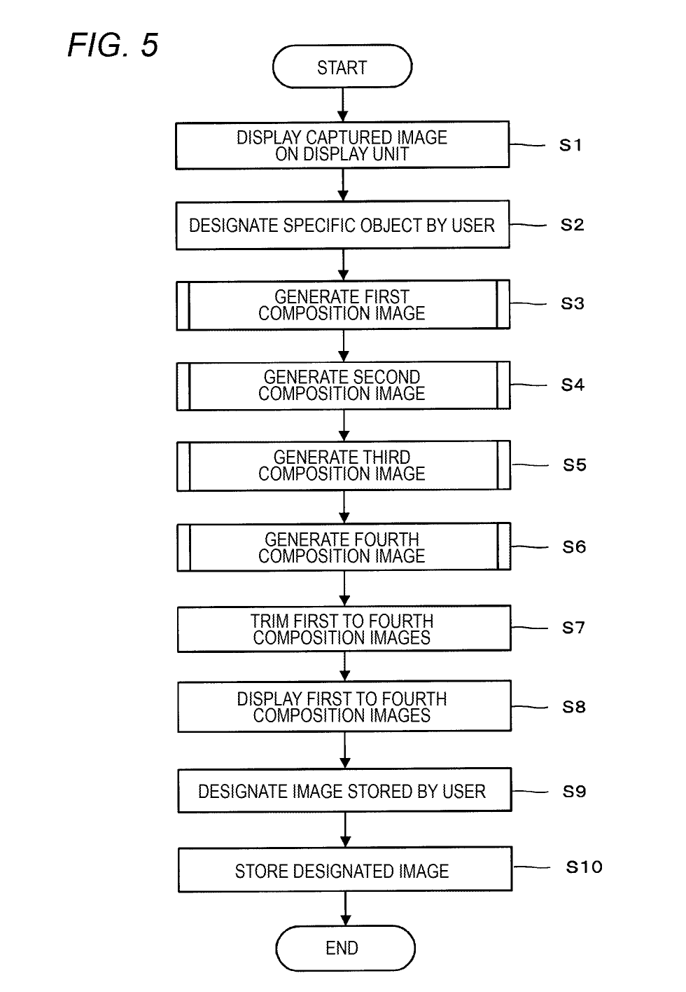

FIG. 5 is a flowchart showing an example of a procedure of a basic concept of the present invention. A basic flow of the present invention will be described below on the basis of the flowchart.

A user displays a plurality of captured images 20 on the display unit 10 and selects the captured image 20 that he or she desires to trim (step Si). The user designates the specific object 30 from the selected captured image 20 (step S2). The extraction processing unit 6 extracts the specific object 30 and the coordinates thereof on the basis of the user's designation. The calculation unit 5 makes the first segmentation composition point 51 coincide with the extracted coordinates, and the composition image generation unit 7 generates the first composition image 41 on the captured image 20 (step S3). Then, the calculation unit 5 sequentially makes the coordinates of the second segmentation composition point 52 to the fourth segmentation composition point 54 coincide with the coordinates of the specific object 30, and the composition image generation unit 7 generates the second composition image 42 to the fourth composition image 44 (step S4 to step S6).

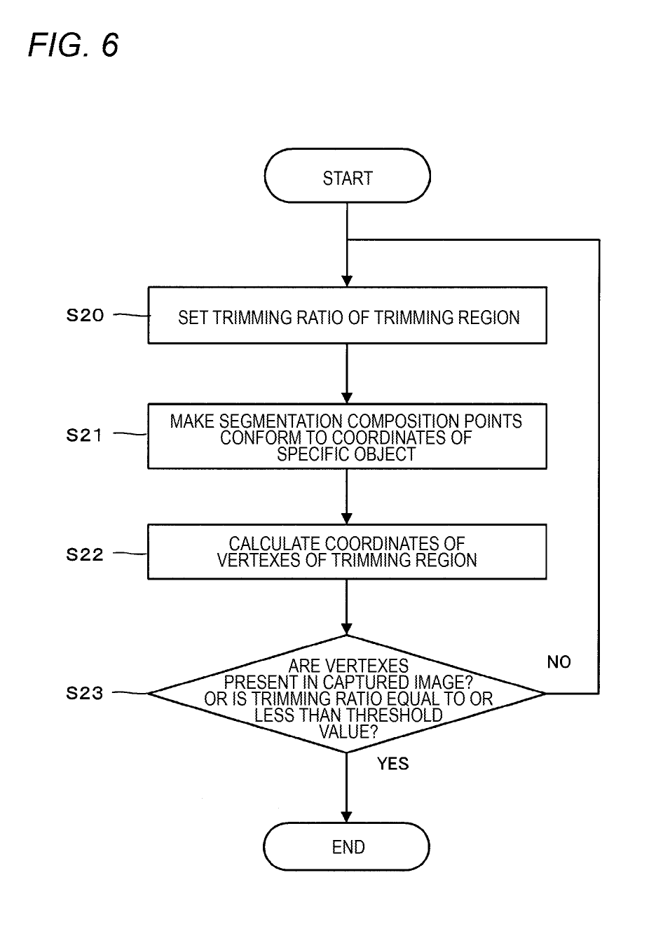

The composition image generation unit 7 trims the first to fourth composition images 41 to 44 on the basis of the segmentation composition points 51 to 54 mentioned above (step S7) and causes the trimming composition images to be stored in the storage unit 4. The composition images 41 to 44 which are finally trimmed are composition images which are generated by changing the trimming ratio M until the protrusion region 40a disappears, and this step will be described in detail in FIG. 6. The first to fourth composition images 41 to 44 are displayed on the display unit 10 in response to a command of the control unit 2 (step S8). A user designates a preferred composition image among the displayed composition images 41 to 44 through tapping or the like (step S9). The control unit 2 causes the designated composition image to be stored in the storage unit 4 and saves the composition image (step S10).

FIG. 6 shows a procedure of a basic concept of the present invention and is a flowchart showing an example of a method of determining whether or not a trimming region is present in a captured image. The method of determining whether or not a trimming region is present in a captured image will be described on the basis of the flowchart.

The trimming ratio M of the trimming region 40 is set from the captured image 20 (step S20). The initial trimming ratio M is the first trimming ratio M1. The coordinates of the specific object 30 are extracted by the extraction processing unit 6, and the segmentation composition points 51 to 54 of the trimming region 40 are made to conform to the coordinates of the specific object 30 (step S21). The coordinates of the vertexes 40b (four points in the embodiment) of the trimming region 40 are calculated by the calculation unit 5 (step S22). The calculation unit 5 determines whether or not the coordinates of the vertexes 40b are present in the region of the captured image 20 or whether or not the first trimming ratio M1 is equal to or less than a threshold value (step S23). When the determination of step S23 is YES, the processing is terminated. When the determination of step S23 is NO, the processing returns to step 20. In step S20, step S20 to step S23 are repeated at the second trimming ratio M2. The trimming ratio M can be indefinitely reduced. However, it is preferable that a composition image be generated at a ratio equal to or higher than a fixed ratio by providing a threshold value.

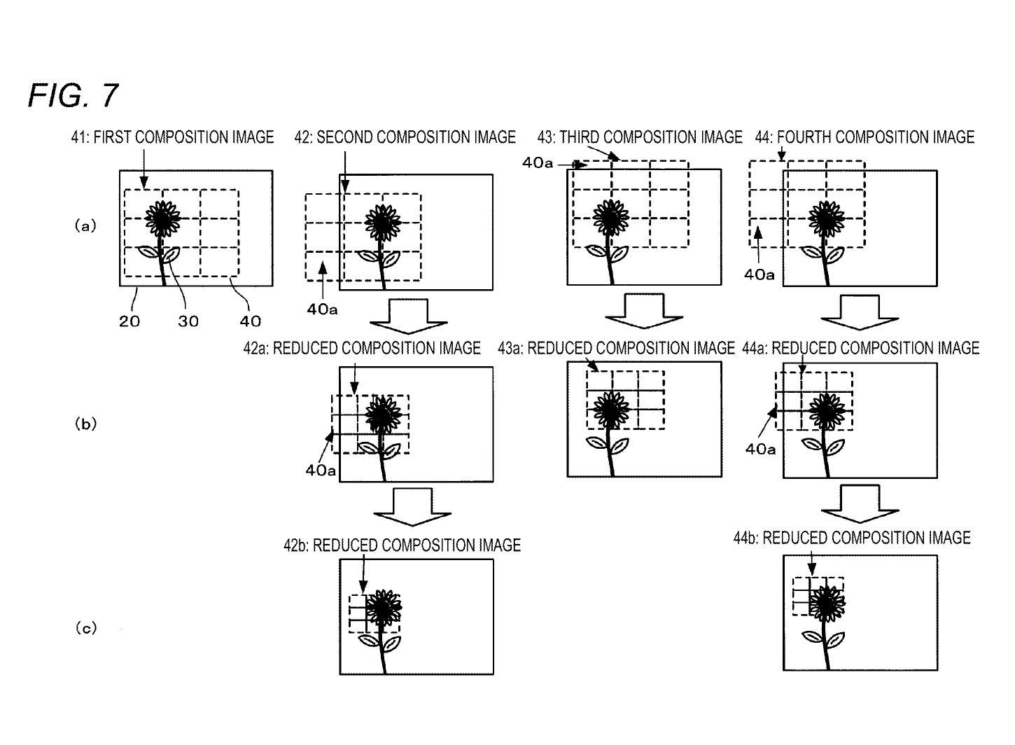

FIG. 7 shows an example of a basic concept of the present invention and is a schematic diagram illustrating the flowcharts of FIGS. 5 and 6 through a specific example. FIG. 7(a) shows first to fourth composition images, FIG. 7(b) shows the reduction processing of the second to fourth composition images, and FIG. 7(c) shows the reduction processing of the second and fourth composition images.

The composition image generation unit 7 generates the first composition image 41 to the fourth composition image 44 at the first trimming ratio M1 on the basis of the captured image 20 which is designated by a user (see FIG. 7(a)). Among the first composition image 41 to the fourth composition image 44, the first composition image 41 does not include a protrusion region 40a, and thus the first composition image 41 is stored in the storage unit 4. On the other hand, since a protrusion region 40a is present in the second composition image 42 to the fourth composition image 44, the composition images 42, 43, and 44 are reduced so as to fit within the region of the captured image 20. The composition image generation unit 7 generates the reduced composition images 42a, 43a, and 44a at the second trimming ratio M2 (see FIG. 7(b)).

However, since the protrusion region 40a is still present in the reduced composition image 42a of the second composition image 42 and the reduced composition image 44a of the fourth composition image 44, the composition image generation unit 7 generates reduced composition images 42b and 44b at a third trimming ratio M3 (see FIG. 7(c)). As described above, when a protrusion region 40a is present, the trimming ratio M of the trimming region 40 is reduced until the protrusion region 40a disappears. However, it is possible to set the number of repeated trimming ratios M and a threshold value of the trimming ratio M. In addition, it has been described that the second trimming ratio M2 may be the same or different for each composition image, but the same is true of the trimming ratio M3.

In the present invention, the trimming region 40 is set from the captured image 20, and the composition images 41 to 44 are generated at the first trimming ratio M1, but a protrusion region 40a may be present. Then, a reduced composition image is generated at the second trimming ratio M2 lower than the first trimming ratio M1 from a composition image including the protrusion region 40a, and a composition image that does not include a protrusion region 40a is finally provided. Accordingly, it is possible to provide a plurality of composition images having different trimming ratios M to a user and to propose an adventurous composition image. In addition, since the composition image centers on the specific object 30, it is also possible to automatically generate a composition image conforming to a region that a user desires to trim, without depending on the user.

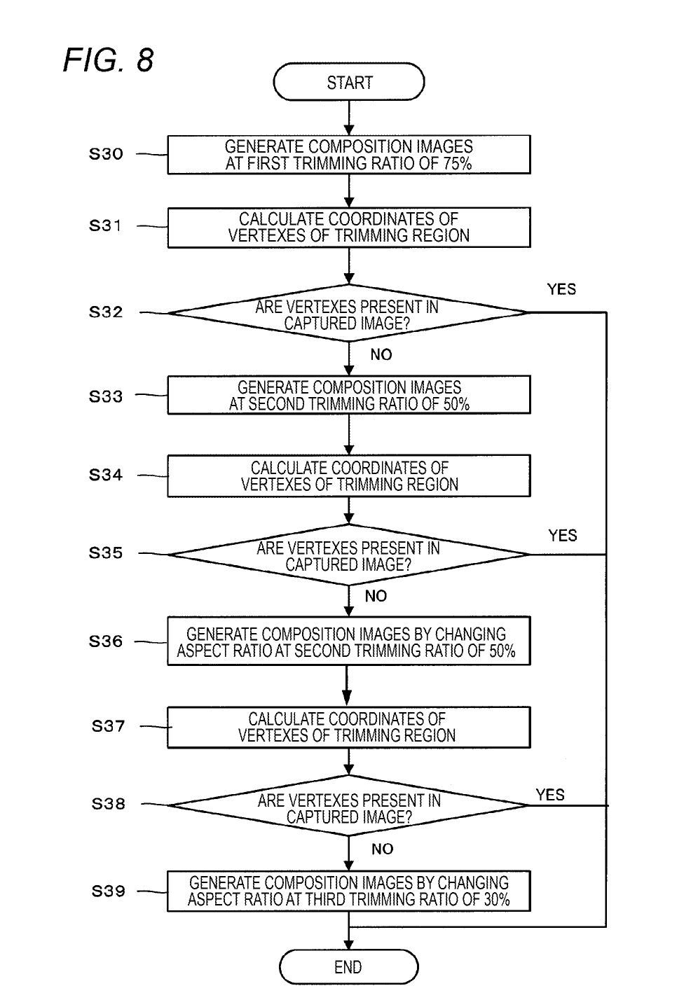

As described above, since an example of a basic concept of the present invention has been described in detail, some embodiments according to the present invention will be described below. FIG. 8 is a flowchart illustrating a procedure according to a first embodiment.

A composition image generation unit 7 generates composition images 41 to 44 at a first trimming ratio M1 (step S30). The trimming ratio M1 is, for example, 75%. The calculation unit 5 calculates the coordinates of vertexes 40b of a trimming region 40 (step S31). The calculation unit 5 determines whether or not the vertexes 40b are present in the captured image 20 (step S32). That is, the vertexes 40b are outside the captured image 20, and it is determined whether or not a protrusion region 40a is present. When it is determined that the vertexes 40b are not present in the captured image 20 (No in step S32), the composition image generation unit 7 generates composition images at a second trimming ratio M2 (step S33). The trimming ratio M2 is, for example, 50%. The calculation unit 5 calculates the coordinates of the vertexes 40b of the trimming region 40 (step S34)

The calculation unit 5 determines whether or not the vertexes 40b are present in the captured image 20 (step S35). When the calculation unit 5 determines that the vertexes 40b are not present in the captured image 20 (NO in step S35), the composition image generation unit 7 changes an aspect ratio N while maintaining the second trimming ratio M2 to thereby generate each composition image (step S36). The calculation unit 5 calculates the coordinates of the vertexes 40b of the trimming region 40 (step S37). The calculation unit 5 determines whether or not the vertexes 40b are present in the captured image 20 (step S38). When it is determined that the vertexes 40b are not present in the captured image 20 (No in step S38), the composition image generation unit 7 generates each composition image at the third trimming ratio M3 (step S39). The trimming ratio M3 is, for example, 30%. When it is determined that the vertexes 40b are present in the captured image 20 (YES in step S32, step S35, and step S38), the processing is terminated.

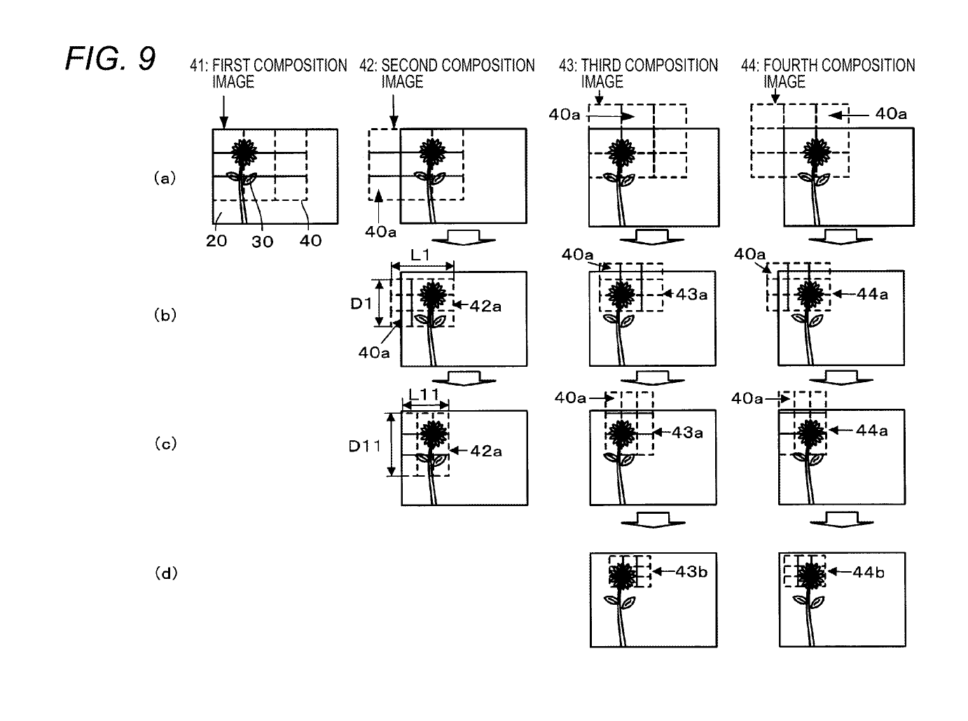

FIG. 9 is a schematic diagram illustrating the first embodiment through a specific example. FIG. 9(a) shows first to fourth composition images, FIG. 9(b) shows the reduction processing of second to fourth composition images, FIG. 9(c) shows the reduction processing of the second to fourth composition images of which the aspect ratios are changed, and FIG. 9(d) shows the reduction processing of the third and fourth composition images.

The composition image generation unit 7 generates the first composition image 41 to the fourth composition image 44 at the first trimming ratio M1 on the basis of the captured image 20 which is designated by a user (see FIG. 9(a)). Among the first composition image 41 to the fourth composition image 44, the first composition image 41 does not include a protrusion region 40a, and thus the first composition image 41 is stored in the storage unit 4. On the other hand, since a protrusion region 40a is present in the second composition image 42 to the fourth composition image 44, the composition images 42, 43, and 44 are reduced so as to fit within the region of the captured image 20. The composition image generation unit 7 generates reduced composition images 42a, 43a, and 44a at the second trimming ratio M2 (see FIG. 9(b)).

However, since the protrusion region 40a is still present in the reduced composition images 42a, 43a, and 44a, the composition image generation unit 7 changes the aspect ratio N while maintaining the second trimming ratio M2 (see FIG. 9(c)). The changed value may be set to a reciprocal value of the aspect ratio N (L1:D1=D11:L11) or may be set to a different ratio (L1:L11≠D1:D11). A protrusion region 40a is not present in the reduced composition image 42a due to changing the aspect ratio, but the protrusion region 40a is still present in the reduced composition images 43a and 44a. Further, the composition image generation unit 7 eliminates the protrusion region 40a by further generating reduced composition images 42b and 44b at the third trimming ratio M3 (see FIG. 9(d)).

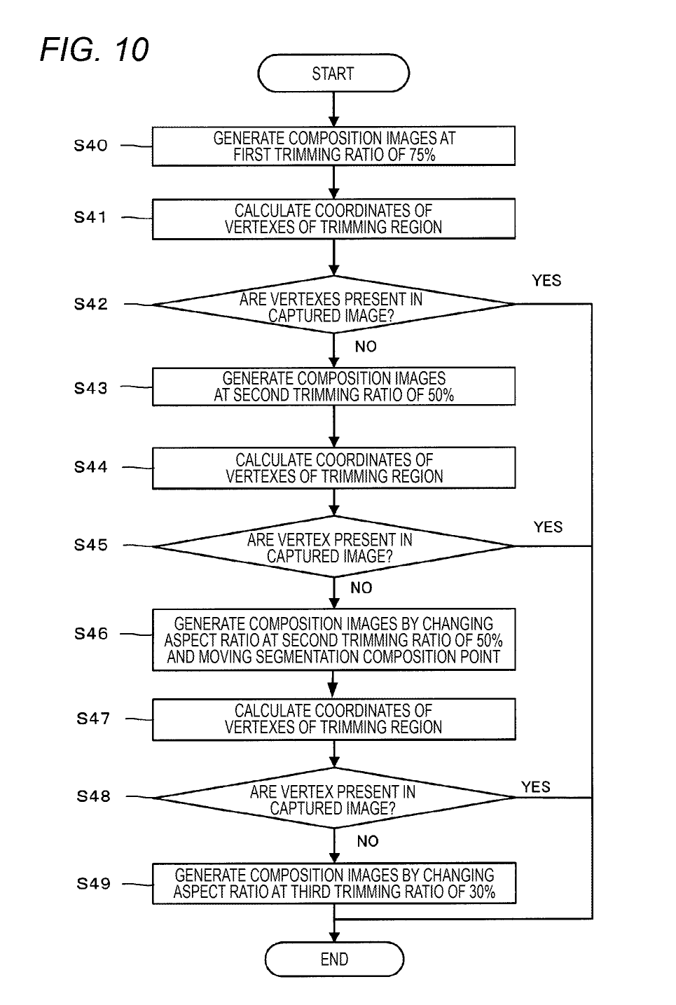

FIG. 10 is a flowchart illustrating a procedure according to a second embodiment of the present invention.

A composition image generation unit 7 generates composition images 41 to 44 at a first trimming ratio M1 (step S40). The trimming ratio M1 is, for example, 75%. The calculation unit 5 calculates the coordinates of a vertexes 40b of a trimming region 40 (step S41). A calculation unit 5 determines whether or not the vertexes 40b are present in a captured image 20 (step S42). When it is determined that the vertexes 40b are not present in the captured image 20 (NO in step S42), the composition image generation unit 7 generates composition images at a second trimming ratio M2 (step S43). The trimming ratio M2 is, for example, 50%. The calculation unit 5 calculates the coordinates of the vertexes 40b of the trimming region 40 (step S44).

The calculation unit 5 determines whether or not the vertexes 40b are present in the captured image 20 (step S45). When it is determined that the vertexes 40b are not present in the captured image 20 (NO in step S45), the composition image generation unit 7 changes an aspect ratio N while maintaining the second trimming ratio M2 and simultaneously changes a segmentation composition point to thereby generate each composition image (step S46). The calculation unit 5 calculates the coordinates of the vertexes 40b of the trimming region 40 (step S47). The calculation unit 5 determines whether or not the vertexes 40b are present in the captured image 20 (step S48). When it is determined that the vertexes 40b are not present in the captured image 20 (NO in step S48), the composition image generation unit 7 generates each composition image at a third trimming ratio M3 (step S49). The trimming ratio M3 is, for example, 30%. When it is determined that the vertexes 40b are present in the captured image 20 (YES in step S42, step S45, and step S48), the processing is terminated.

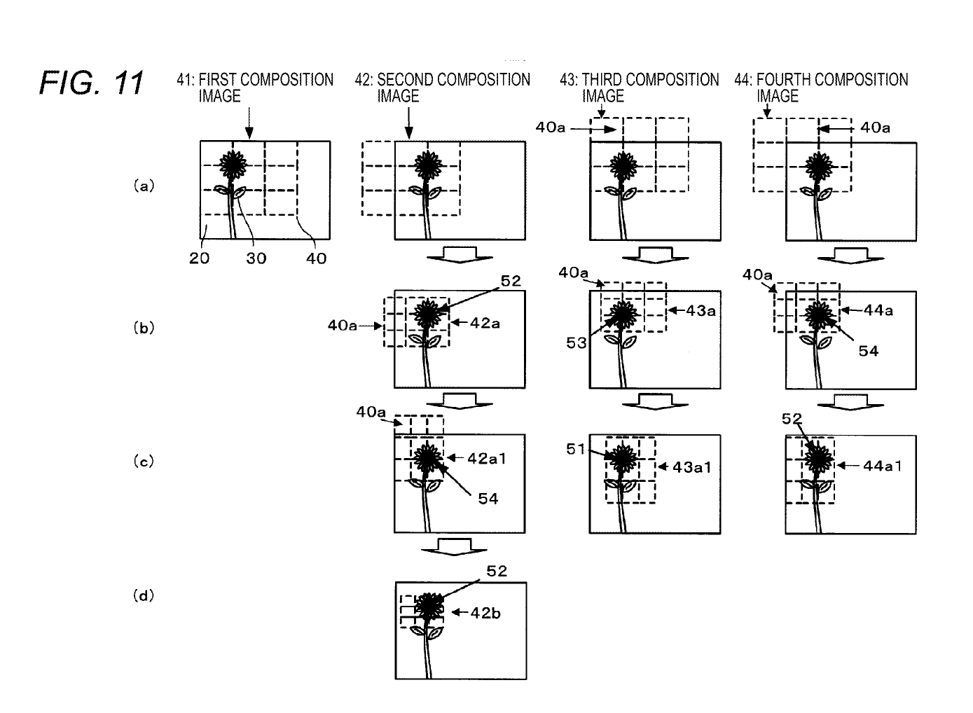

FIG. 11 is a schematic diagram illustrating the second embodiment through a specific example. FIG. 11(a) shows first to fourth composition images, FIG. 11(b) shows the reduction processing of the second to fourth composition images, FIG. 11(c) shows the reduction processing of the second to fourth composition images of which the aspect ratios and the segmentation composition points are changed, and FIG. 11(d) shows the reduction processing of the second composition image.

The composition image generation unit 7 generates the first composition image 41 to the fourth composition image 44 at the first trimming ratio M1 on the basis of the captured image 20 which is designated by a user (see FIG. 11(a)). Among the first composition image 41 to the fourth composition image 44, the first composition image 41 does not include a protrusion region 40a, and thus the first composition image 41 is stored in the storage unit 4. On the other hand, since a protrusion region 40a is present in the second composition image 42 to the fourth composition image 44, the composition images 42, 43, and 44 are reduced so as to fit within the region of the captured image 20. The composition image generation unit 7 generates reduced composition images 42a, 43a, and 44a at the second trimming ratio M2 (see FIG. 11(b)).

However, since the protrusion region 40a is still present in the reduced composition images 42a, 43a, and 44a, the composition image generation unit 7 changes the aspect ratio N while maintaining the second trimming ratio M2 and changes the position of the segmentation composition point (see FIG. 11(c)). Also in the step of the second trimming ratio M2, the protrusion region 40a is still present in the changed reduced composition image 42a1, and thus the composition image generation unit 7 generates a reduced composition image 42b at the third trimming ratio M3 (see FIG. 11(d)). In reduced composition images 43a1 and 44a1, changing the aspect ratio N causes the segmentation composition points to move, and thus a protrusion region 40a is not present.

In the reduced composition image 42a of the second composition image 42, a second segmentation composition point 52 coincides with the coordinates of the specific object 30 (see FIG. 11(b)), and the aspect ratio N thereof is changed and a fourth segmentation composition point 54 is made to coincide with the coordinates of the specific object 30 to thereby generate the new reduced composition image 42a1 (see FIG. 11(c)). This procedure is the same as in the third composition image 43 and the fourth composition image 44. In addition, the point movement of the segmentation composition point which is changed is the movement to the segmentation composition point opposite thereto in the vertical direction in the second embodiment, but may be set in accordance with each composition image. In the second composition image 42, the fourth segmentation composition point 54 of the reduced composition image 42a1 which is changed to is set as a point coincident with the coordinates of the specific object 30. However, the second segmentation composition point 52 of the reduced composition image 42b reduced at the trimming ratio M3 returns to the point coincident with the coordinates of the specific object 30. Which segmentation composition point is selected can be set depending on the reduced composition images, a positional relationship of the protrusion region 40a, and the designated specific object 30.

In addition, when the aspect ratio N is changed, the trimming ratio M may also be changed regardless of the presence of a protrusion region 40a. In the case of this embodiment, the reduced composition images 43a1 and 44a1 of FIGS. 11(c) and 11(d) may be further reduced by setting the trimming ratios thereof to M3.

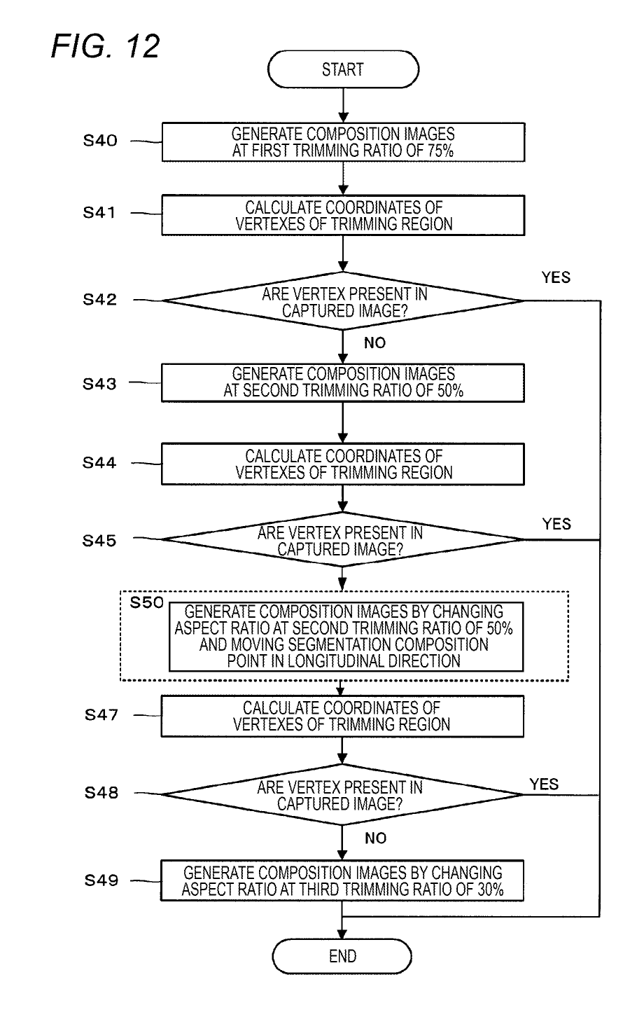

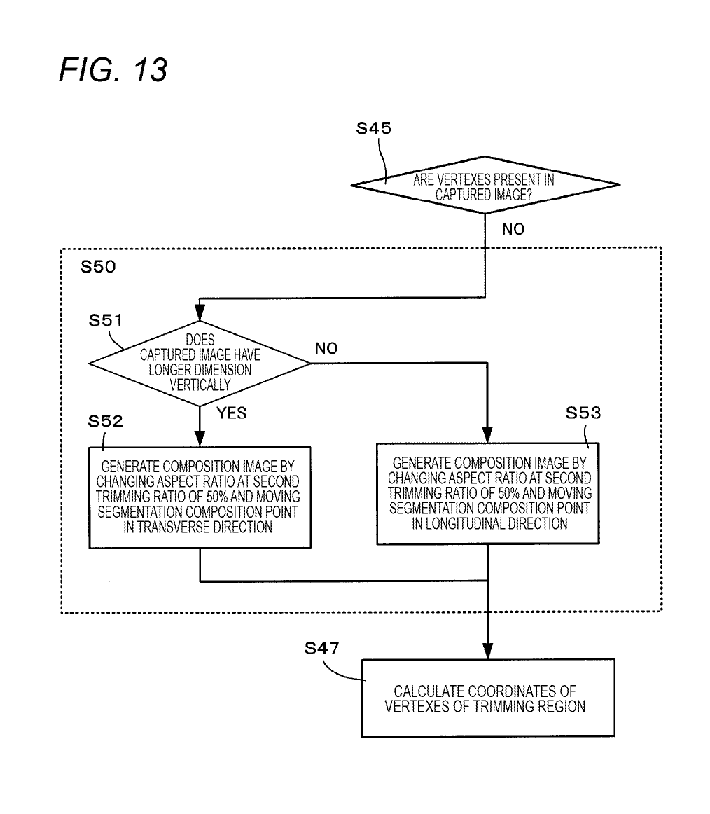

FIGS. 12 and 13 are flowcharts illustrating a procedure according to a third embodiment of the present invention. Here, step S50 which is added to a modified second embodiment will be described. Since the other configurations are the same as those in the second embodiment, the same reference numerals and signs are used, and a description thereof will be omitted here. Here, step S50 is added between step S45 and step S47 in the second embodiment.

A composition image generation unit 7 generates composition images at a second trimming ratio M2, and a calculation unit 5 calculates the coordinates of vertexes 40b of a trimming region 40 and then determines whether or not the vertexes 40b are present in a captured image 20 (step S45). When the calculation unit determines that the vertexes 40b are not present in the captured image 20 (NO in step S45), it is determined whether or not the captured image 20 has a longer dimension vertically (D>L) (step S51). When it is determined that the captured image has a longer dimension vertically (YES in step S51), the composition image generation unit 7 changes an aspect ratio N while maintaining a second trimming ratio M2 and moves a segmentation composition point in the transverse direction to thereby generate each composition image. In addition, it is determined that the captured image does not have a longer dimension vertically (NO in step S51), the composition image generation unit 7 changes the aspect ratio N while maintaining the second trimming ratio M2 and moves the segmentation composition point in the vertical direction to thereby generate each composition image (step S53).

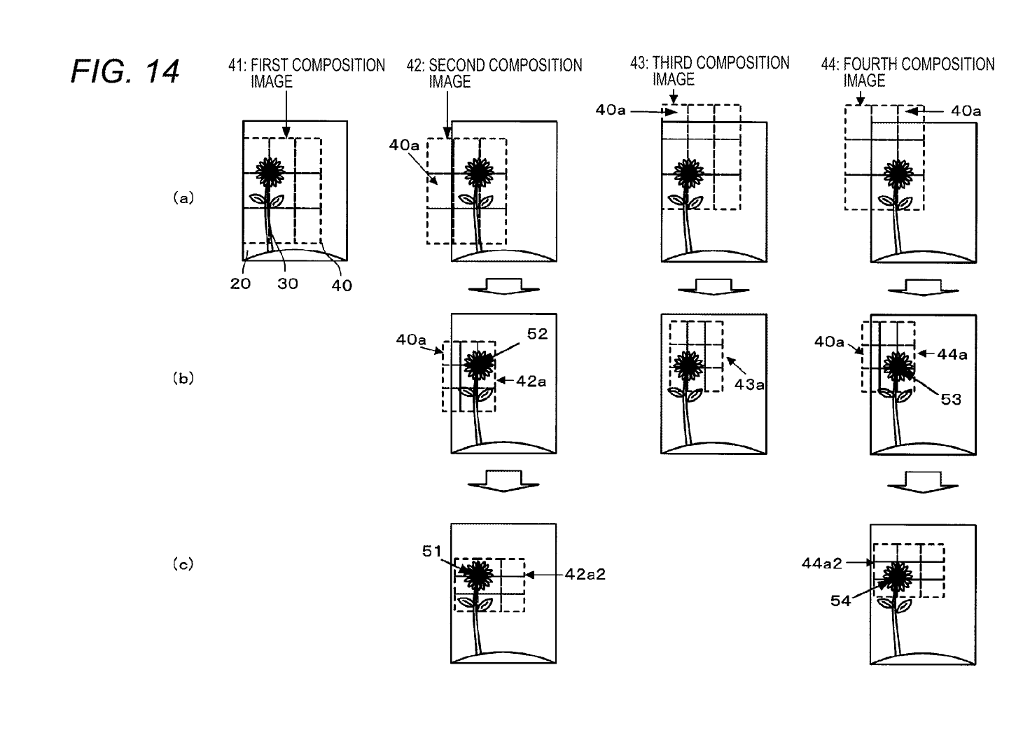

FIG. 14 is a schematic diagram illustrating the third embodiment through a specific example. FIG. 14(a) shows first to fourth composition images, FIG. 14(b) shows the reduction processing of the second to fourth composition images, and FIG. 14(c) shows changes in aspect ratios and segmentation composition points of the second and fourth composition images.

The composition image generation unit 7 generates the first composition image 41 to the fourth composition image 44 at a first trimming ratio M1 on the basis of the captured image 20 which is designated by a user (see FIG. 14(a)). In the third embodiment, since a description is given of an example in which the captured image 20 has a longer dimension vertically, the composition images 41 to 44 which are described in detail in the first and second embodiments have different longitudinal and lateral sizes. That is, the size of the trimming region 40 is also vertically long in accordance with the longer dimension vertically. Among the first composition image 41 to the fourth composition image 44, the first composition image 41 does not include a protrusion region 40a, and thus the first composition image 41 is stored in the storage unit 4. On the other hand, since a protrusion region 40a is present in the second composition image 42 to the fourth composition image 44, the composition images 42, 43, and 44 are reduced so as to fit within the region of the captured image 20. The composition image generation unit 7 generates reduced composition images 42a, 43a, and 44a at the second trimming ratio M2 (see FIG. 14(b)).

However, since the protrusion region 40a is still present in the reduced composition images 42a and 44a, the composition image generation unit 7 changes the aspect ratio N while maintaining the second trimming ratio M2 and changes the position of the segmentation composition point. The composition image generation unit 7 generates reduced composition images 42a2 and 44a2 at the second trimming ratio M2 (see FIG. 14(c)). In addition, since a protrusion region 40a is not present in the reduced composition images 42a2 and 44a2, step S49 is not performed. In addition, the captured image 20 having a longer dimension vertically and the captured image 20 having a longer dimension horizontally (L>D) are different from each other in the change in the position of the segmentation composition point. That is, when the captured image 20 has a longer dimension vertically, movement in the transverse direction to a segmentation composition point is performed (the first segmentation composition point 51 from/to the second segmentation composition point 52 or the third segmentation composition point 53 from/to the fourth segmentation composition point 54). When the captured image 20 has a longer dimension horizontally, the movement to a segmentation composition point present in the vertical direction is performed (the first segmentation composition point 51 from/to the third segmentation composition point 53 or the second segmentation composition point 52 from/to the fourth segmentation composition point 54).

In the reduced composition image 42a of the second composition image 42, the second segmentation composition point 52 coincides with the coordinates of the specific object 30 (see FIG. 14(b)), and the aspect ratio N thereof is changed and the first segmentation composition point 51 is made to coincide with the coordinates of the specific object 30 to thereby generate the new reduced composition image 42a2 (see FIG. 14(c)). This procedure is the same as in the fourth composition image 44. As described above, when the captured image 20 has a longer dimension vertically, the trimming region 40 is made to have a longer dimension vertically. When the captured image 20 has a longer dimension horizontally, the trimming region 40 is made to have a longer dimension horizontally. Accordingly, the trimming region 40 conforming to the size of the captured image 20 is set. Thus, it is possible to perform trimming suitable for the size of the captured image 20. In addition, when a protrusion region 40a is present, it is possible to eliminate the protrusion region 40a by using a method of changing the aspect ratio N of the trimming region 40 and changing a segmentation composition point without changing a trimming ratio M as much as possible.

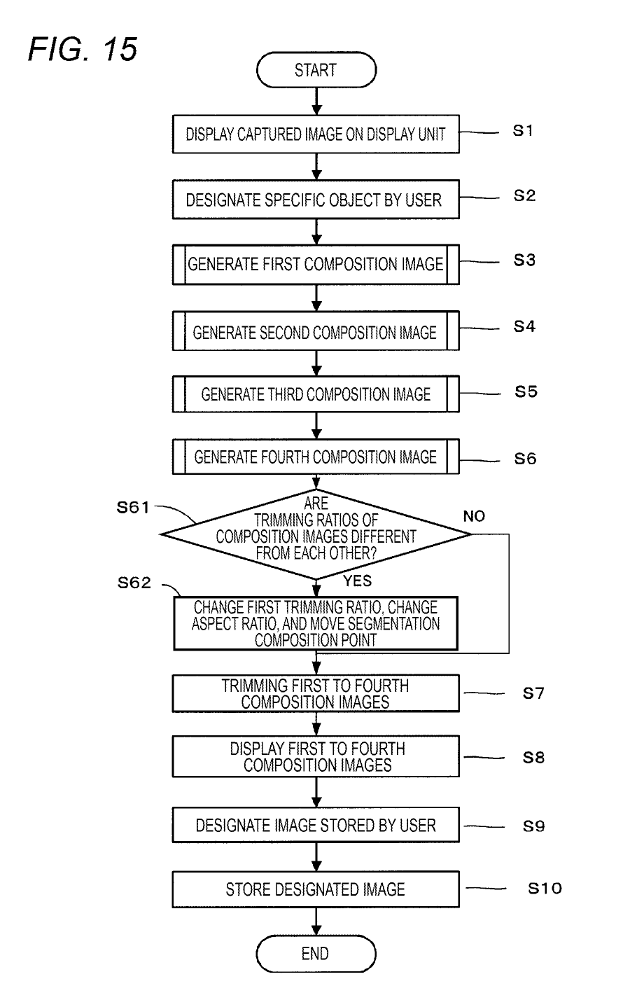

FIG. 15 is a flowchart illustrating a procedure according to a fourth embodiment of the present invention. The fourth embodiment has the same procedure as that of the basic concept of FIG. 5, and step S61 and step S62 which are added to the procedure of the basic concept will be described. The other configurations use the same reference numerals and signs as those in FIG. 5, and a description thereof will be omitted here.

A composition image generation unit 7 generates a first composition image 41 to a fourth composition image 44 which do not include a protrusion region 40a on the basis of a captured image 20 which is designated by a user (step S1 to step S6). It is determined whether or not the composition images 41 to 44 have different trimming ratios M (step S61). Here, various determination methods may be used. For example, it is possible to set conditions where one composition image having a first trimming ratio M1 is present and the other composition images have a second trimming ratio M2. When it is determined that the trimming ratios M thereof are different from each other (YES in step S61), the composition image generation unit 7 changes the ratio of the composition image having the first trimming ratio M1, changes the aspect ratio N thereof, and moves a segmentation composition point to thereby generate a new composition image (step S62). When it is determined that the trimming ratios M thereof are the same as each other (YES in step S61), step S62 is skipped, and step S7 is performed.

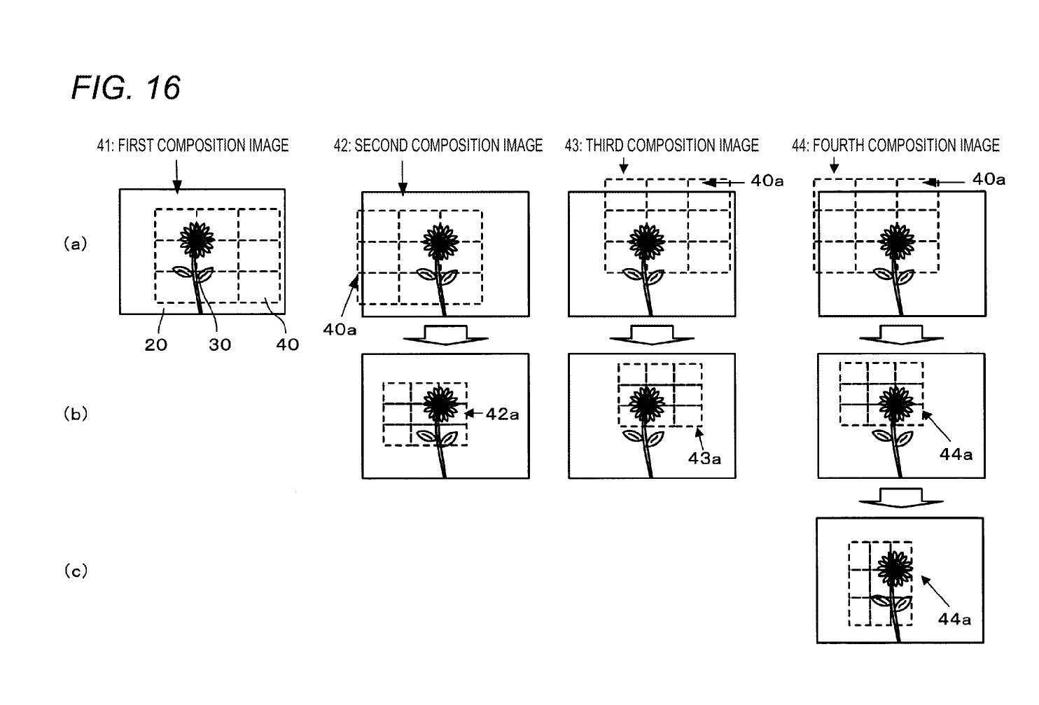

FIG. 16 is a schematic diagram illustrating the fourth embodiment of the present invention through a specific example. FIG. 16(a) shows first to fourth composition images, FIG. 16(b) shows the reduction processing of the second to fourth composition images, FIG. 16(c) shows a change in a trimming ratio of the first composition image, and FIG. 16(d) shows changes in an aspect ratio and a segmentation composition point.

The composition image generation unit 7 generates the first composition image 41 to the fourth composition image 44 at a first trimming ratio M1 on the basis of the captured image 20 which is designated by a user (see FIG. 16(a)). Among the first composition image 41 to the fourth composition image 44, the first composition image 41 does not include a protrusion region 40a, and thus the first composition image 41 is stored in the storage unit 4. On the other hand, since a protrusion region 40a is present in the second composition image 42 to the fourth composition image 44, the composition images 42, 43, and 44 are reduced so as to fit within the region of the captured image 20. The composition image generation unit 7 generates reduced composition images 42a, 43a, and 44a at a second trimming ratio M2 (see FIG. 16(b)).

In this manner, all composition images to be displayed on a display unit 10 can be generated, but the aspect ratios N of all of the composition images are the same as each other. Here, a fourth segmentation composition point 54 of the fourth composition image 44 is changed to a second segmentation composition point 52, and the aspect ratio N thereof is changed (see FIG. 16(c)). The fourth composition image 44 does not include a protrusion region 40a at the second trimming ratio M2, but it is possible to provide an adventurous composition image by changes in the aspect ratio N and segmentation composition point thereof. Particularly, in this case, the fourth composition image 44 has a trimming ratio M and an aspect ratio N which are different from those of the first composition image 41 which is located diagonally therefrom when all of the composition images are displayed on the display unit 10, and thus it is possible to propose an adventurous composition image having different impressions.

In addition, when the aspect ratio N is changed, the trimming ratio M may also be changed regardless of the presence of a protrusion region 40a. In the case of this embodiment, the fourth composition image 44 of FIG. 16(c) may be reduced by setting the trimming ratio thereof to M3.

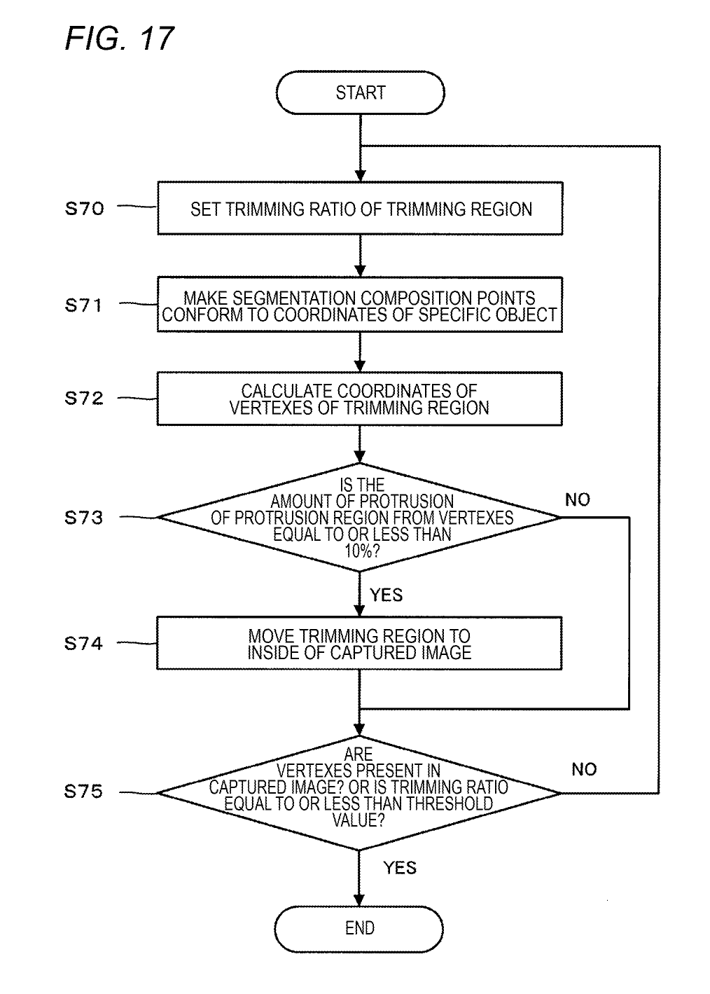

FIG. 17 is a flowchart illustrating a procedure according to a fifth embodiment of the present invention.

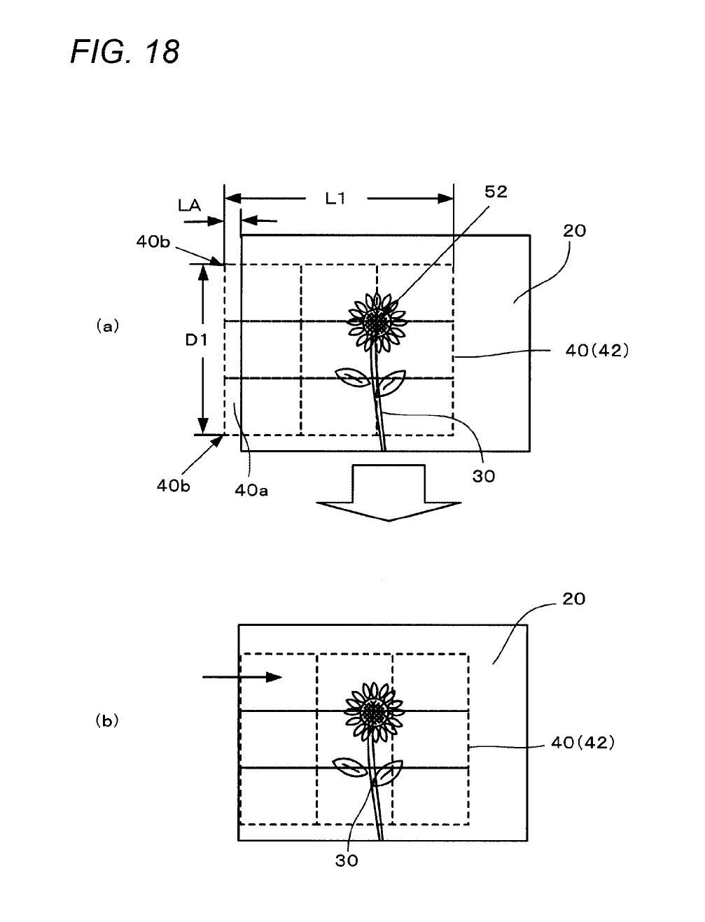

A trimming ratio M of a trimming region 40 is set from a captured image 20 (step S70). The initial trimming ratio M is the first trimming ratio M1. The coordinates of a specific object 30 are extracted by an extraction processing unit 6, and segmentation composition points 51 to 54 of the trimming region 40 are made to conform to the coordinates of the specific object 30 (step S71). A calculation unit 5 calculates the coordinates of vertexes 40b (four points in the embodiment) of the trimming region 40 (step S72). A proportion T of a protrusion region from the vertexes 40b is calculated by the calculation unit 5, and it is determined whether or not the proportion is equal to or less than 10% of a trimming region (step S73). The calculation of the proportion T of the protrusion region will be described in detail in FIG. 18.

When the proportion T of the protrusion region to the vertexes 40b is equal to or less than 10% of the trimming region (YES in step S73), a composition image generation unit 7 moves the trimming region 40 so that the entire trimming region 40 fits within the captured image 20 (step S74). When the proportion T of the protrusion region to the vertexes 40b exceeds 10% of the trimming region (NO in step S73), step S74 is skipped, and step S75 is performed. The calculation unit 5 determines whether or not the coordinates of the vertexes 40b are within the region of the captured image 20 or whether or not the first trimming ratio M1 is equal to or less than a threshold value (step S75). When the determination of step S75 is YES, the processing is terminated. When the determination of step S75 is NO, the processing returns to step S70. In step S70, step S70 to step S75 are repeated at a second trimming ratio M2.

FIG. 18 is a schematic diagram illustrating the fifth embodiment through a specific example. FIG. 18(a) shows a positional relationship between a trimming region and a captured image and FIG. 18(b) shows the movement of the trimming region to the inside of the captured image.

The trimming region 40 having the first trimming ratio M1 is set within the captured image 20. The fifth embodiment shows the second composition image 42 as an example in which a second segmentation composition point 52 coincides with the coordinates of the specific object 30. Among the four vertexes 40b of the trimming region 40, two vertexes 40b on the left side of the drawing are outside the region (outer edge) of the captured image 20 and have a protrusion region 40a. The protrusion region 40a protrudes to the left side of the captured image 20 by a protrusion length LA. The proportion T of the protrusion region to the vertexes 40b may be, for example, the amount of protrusion with respect to a horizontal width L1 (LA/L1), may be the amount of protrusion with respect to an area (LA×D1/L1×D1), or may be a proportion of the number of pixels. Although the vertexes 40b protruding in the transverse direction have been described, this is the same as in the vertical direction or both in the transverse direction and the vertical direction. When the proportion T of the protrusion region to the vertexes 40b is, for example, equal to or less than 10%, the movement of the trimming region 40, such as parallel movement, is performed so that the trimming region 40 fits within the captured image 20 (see FIG. 18(b)).

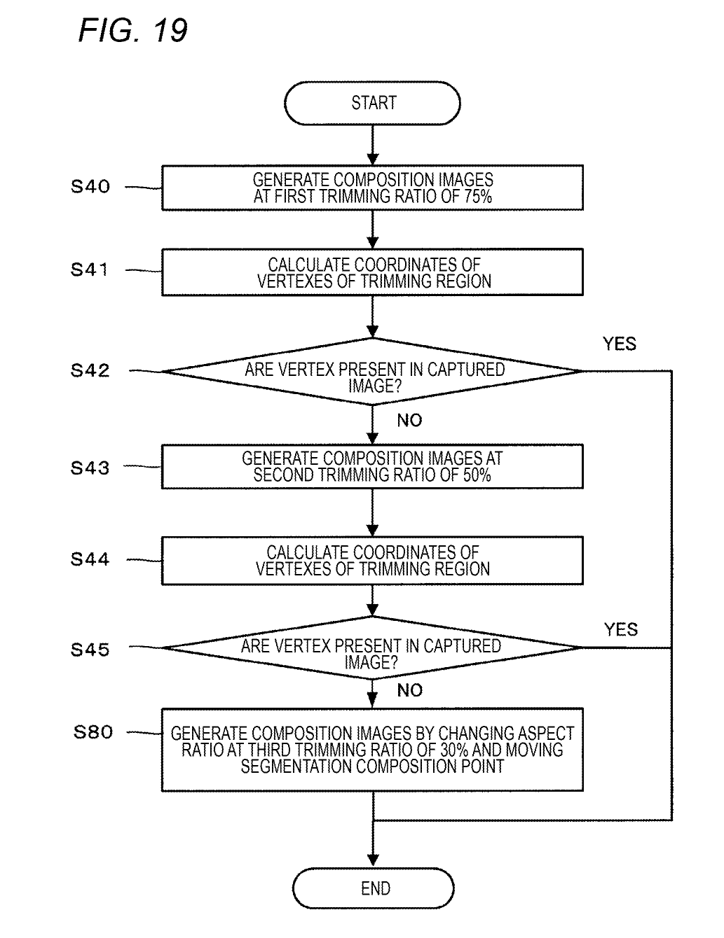

FIG. 19 is a flowchart illustrating a procedure according to a sixth embodiment of the present invention. Here, step S80 which is added to a modified second embodiment will be described. Since the other configurations are the same as those in the second embodiment, the same reference numerals and signs are used, and a description thereof will be omitted here. Here, step S80 is added in place of step S46 to step S49 in the second embodiment.

A composition image generation unit 7 generates composition images at a second trimming ratio M2, and a calculation unit 5 calculates the coordinates of vertexes 40b of a trimming region 40 and then determines whether or not the vertexes 40b are present in a captured image 20 (step S45). When the calculation unit determines that the vertexes 40b are not present in the captured image 20 (NO in step S45), a trimming ratio is changed from the second trimming ratio M2 to a third trimming ratio M3, an aspect ratio N is changed, and a segmentation composition point is changed, thereby generating each composition image (step S80).

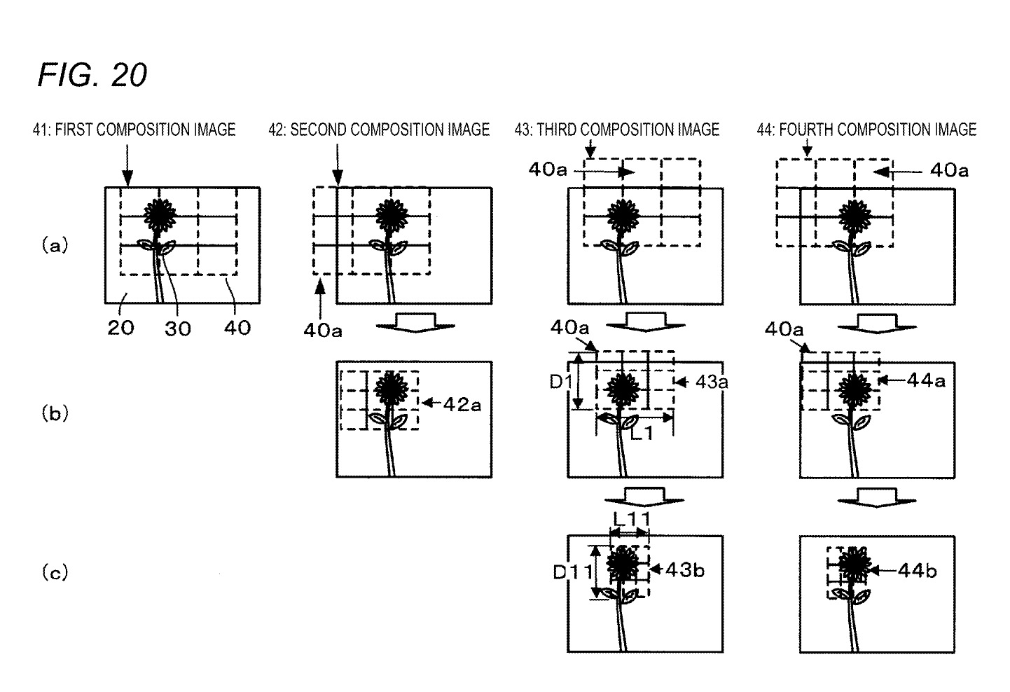

FIG. 20 is a schematic diagram illustrating the sixth embodiment through a specific example. FIG. 20(a) shows first to fourth composition images, FIG. 20(b) shows the reduction processing of the second to fourth composition images, and FIG. 20(c) shows changes in a trimming ratio, an aspect ratio, and a segmentation composition point of the second composition image.

The composition image generation unit 7 generates first composition image 41 to fourth composition image 44 at the first trimming ratio M1 on the basis of the captured image 20 which is designated by a user (see FIG. 20(a)). Among the first composition image 41 to the fourth composition image 44, the first composition image 41 does not include a protrusion region 40a, and thus the first composition image 41 is stored in the storage unit 4. On the other hand, since a protrusion region 40a is present in the second composition image 42 to the fourth composition image 44, the composition images 42, 43, and 44 are reduced so as to fit within the region of the captured image 20. The composition image generation unit 7 generates reduced composition images 42a, 43a, and 44a at the second trimming ratio M2 (see FIG. 20(b)).

The reduced composition image 42a does not include a protrusion region 40a, and thus is stored in the storage unit 4. However, a protrusion region 40a is still present in the reduced composition images 43a and 44a. Here, the composition image generation unit 7 changes the second trimming ratio M2 to a third trimming ratio, changes an aspect ratio N, and changes the position of a segmentation composition point (see FIG. 20(c)). As a result, reduced composition images 43b and 44b that does not include a protrusion region 40a are generated, and thus are stored in the storage unit 4.

In addition, the present invention is not limited to the above-described embodiments, and modifications and improvements can be made appropriately. Moreover, the materials, shapes, dimensions, numerical values, forms, numbers, arrangement places, and the like of the respective components in the above-described embodiments are arbitrary as long as the present invention can be achieved, and are not limited.

This application is based on Japanese patent application No. 2012-192072 filed on Aug. 31, 2012, the contents of which are incorporated herein by reference.

### INDUSTRIAL APPLICABILITY

An image processing device, an image processing method, and an image processing program according to the present invention can be used to provide an adventurous composition image to a user by displaying a plurality of composition images including a specific object, for example, in the imaging of a digital camera or a portable terminal.

### REFERENCE SIGNS LIST

1: Image processing device

2: Control unit

3: Imaging unit

5: Calculation unit

6: Extraction processing unit

7: Composition image generation unit

10: Display unit

20: Captured image

30: Specific object

40: Trimming region

40a: Protrusion region

40b: Vertex

41: First composition image

42: Second composition image

43: Third composition image

44: Fourth composition image

51: First segmentation composition point

52: Second segmentation composition point

53: Third segmentation composition point

54: Fourth segmentation composition point

D (D1, D2): Vertical width

L (L1, L2): Horizontal width

M: Trimming ratio

M1: First trimming ratio

M2: Second trimming ratio

M3: Third trimming ratio

N: Aspect ratio

T: Proportion of protrusion region from vertexes

1. An image processing device comprising:
an imaging unit which captures an image including a specific object;
an extraction processing unit which extracts the specific object in the captured image;
a composition image generation unit that generates a plurality of composition images, which have a first trimming ratio and respectively have a plurality of different segmentation composition points being disposed in the specific object, from the captured image;
a calculation unit which calculates whether or not a protrusion region protruding from an outer edge of the captured image is present in the plurality of composition images generated based on the first trimming ratio; and
a display unit which displays the captured image and the composition images, wherein
when the calculation unit calculates that one or more protrusion regions are present, the composition image generation unit generates reduced composition images which include the specific object and have a second trimming ratio lower than the first trimming ratio.

2. The image processing device according to claim 1, wherein when the calculation unit calculates that one or more protrusion regions are present in the reduced composition images having the second trimming ratio, the composition image generation unit generates further reduced composition images, including the specific object, which have a third trimming ratio lower than the second trimming ratio.

3. The image processing device according to claim 2, wherein the reduced composition image having the second trimming ratio has an aspect ratio constituted by a ratio of a horizontal width to a vertical width of the captured image, and
wherein the composition image generation unit processes the composition image including the protrusion region among the reduced composition images to generate a composition image which is a reduced composition image having a reverse aspect ratio while maintaining the second trimming ratio.

4. The image processing device according to claim 2, wherein the reduced composition image having the second trimming ratio includes an aspect ratio constituted by a ratio of a horizontal width to a vertical width of the captured image, and
wherein the composition image generation unit processes the composition image including the protrusion region among the reduced composition images to generate a composition image which is a reduced composition image having a reverse aspect ratio at the third trimming ratio.

5. The image processing device according to claim 3, wherein the composition image generation unit disposes a different segmentation composition point from the segmentation composition points in the specific object with respect to the composition image having the reverse aspect ratio.

6. The image processing device according to claim 5, wherein the composition image generation unit moves the segmentation composition point in a vertical direction.

7. The image processing device according to claim 5, wherein the composition image generation unit moves the segmentation composition point in a transverse direction.

8. The image processing device according to claim 5, wherein when the captured image has a longer dimension horizontally, the composition image generation unit moves the segmentation composition point in a vertical direction, and when the captured image has a longer dimension vertically, the composition image generation unit moves the segmentation composition point in a transverse direction.

9. The image processing device according to claim 1, wherein an aspect ratio is reversed also with respect to a composition image that does not include a protrusion region.

10. The image processing device according to claim 1, wherein when a proportion of a protrusion region with respect to the composition image is equal to or less than a predetermined value, the segmentation composition point is shifted so that a trimming region fits within the captured image.

11. The image processing device according to claim 1, wherein the first trimming ratio is in a range of 70% to 85%, and the second trimming ratio is in a range of 40% to 60%.

12. The image processing device according to claim 1, wherein four segmentation composition points are present.

13. An image processing method comprising the steps of:
capturing an image including a specific object;
extracting the specific object in the captured image;
generating a plurality of composition images, which have a first trimming ratio and respectively have a plurality of different segmentation composition points being disposed in the specific object, from the captured image;
calculating whether or not a protrusion region protruding from an outer edge of the captured image is present in the plurality of composition images generated based on the first trimming ratio;
generating reduced composition images which include the specific object and have a second trimming ratio lower than the first trimming ratio when it is calculated that one or more protrusion regions are present; and
displaying the plurality of composition images.

14. A computer-readable storage medium in which is stored an image processing program which causes a computer to process a captured image, the program causing the computer to perform:
a process of capturing an image including a specific object;
a process of extracting the specific object in the captured image;
a process of generating a plurality of composition images, which have a first trimming ratio and respectively have a plurality of different segmentation composition points being disposed in the specific object, from the captured image;
a process of calculating whether or not a protrusion region protruding from an outer edge of the captured image is present in the plurality of composition images generated based on the first trimming ratio;
a process of generating reduced composition images which include the specific object and have a second trimming ratio lower than the first trimming ratio when it is calculated that one or more protrusion regions are present; and
a process of displaying the plurality of composition images.
